(19) United States
(12) Patent Application Publication
(10) Pub. No.: US 2012/0146860 A1
(43) Pub. Date: Jun. 14, 2012

(54) COMMUNICATION SYSTEM AND COMMUNICATION APPARATUS

(76) Inventors: Koichiro Nakase, Tokyo (JP); Akira Miyata, Tokyo (JP); Tsuneo Tsukagoshi, Tokyo (JP)

(21) Appl. No.: 13/392,076

(22) PCT Filed: Jun. 16, 2010
(86) PCT No.: PCT/JP2010/004007

§ 371 Date: Feb. 23, 2012

(30) Foreign Application Priority Data
Sep. 1, 2009 (JP) 2009-202114

(51) Int. Cl. H01Q 1/24

(52) U.S. Cl. 343/702

(57) ABSTRACT

A communication system according to the present invention includes: a communication coupler that transmits a signal outputted from a communication equipment; and a signal transmission apparatus that performs communication by propagating, as an electromagnetic field, a signal transmitted from the communication coupler. The communication coupler includes: a coupler case; and an extended conductor portion that is provided at an end portion of the coupler case, the end portion facing the signal transmission apparatus, the extended conductor portion extends so as to be parallel to the signal transmission apparatus, and the extended conductor portion increases electromagnetic coupling between the communication coupler and the signal transmission apparatus.

### TECHNICAL FIELD

The present invention relates to a communication system that includes a sheet-type signal transmission apparatus that is a communication medium, and a communication coupler that is installed thereon and sends and receives signals to/from the signal transmission apparatus, and in particular relates to a communication system and a communication apparatus having a leaking electromagnetic field suppressing structure that inhibits electromagnetic leakage from the communication coupler.

### BACKGROUND ART

In recent years, instead of a conventional wireless system that performs wireless communication by propagating electromagnetic waves through space, a new communication system has been developed and put to practical use as disclosed in Patent Document 1. This communication system performs communication by propagating an electromagnetic field in a sheet-type communication medium.

This kind of communication system is constituted from a sheet-type signal transmission apparatus 1 and a communication coupler 2 as shown in FIG. 12.

The signal transmission apparatus 1 is a sheet-type structure that has a mesh conductor portion 3, a lower electrode 4 that is arranged spaced apart from the content portion 3, a first dielectric layer 5 that is provided on the upper portion of the conductor portion 3, and a second dielectric layer 6 that is provided in the sandwiched region between the conductor portion 3 and the lower electrode 4. FIG. 13 is a plan view showing the conductor portion 3 of the signal transmission device 1 from above, and shows that the conductor portion 3 is in a mesh state.

As shown in the cross-sectional view of FIG. 12, and the perspective view of FIG. 14, the communication coupler 2 has a disk-shaped inner conductor 10, an outer conductor 12 that is formed so as to cover the inner conductor 10 to form a coupler housing 11, and a coaxial cable 13 that is connected to the inner conductor 10 and the outer conductor 12. The end of the coaxial cable 13 is connected to a communication equipment 14. With this kind of constitution, an electromagnetic field that is input/output to/from the communication equipment 14 passes through the coaxial cable 13, and propagates between the inner conductor 10 and the outer conductor 12 of the communication coupler 2 to be injected to the signal transmission apparatus 1, and thereafter propagates within this signal transmission apparatus 1 to perform communication between the communication coupler 2 and another communication coupler (not illustrated).

In the communication apparatus that is shown in Patent Documents 2 to 4, by causing an electromagnetic field to exist in the sandwiched area that is sandwiched by sheet bodies that serve as mutually facing conductor portions, and changing the impressed voltage between the two sheet bodies, communication is performed by advancing an electromagnetic field, in the same manner as the aforementioned Patent Document 1.

Specifically, in the communication apparatus that is shown in Patent Document 2, the sheet-type (foil type, film type) first conductor layer and the second conductor layer having an opening are constituted by being arranged approximately parallel via an insulating layer. By supplying a cylindrical symmetrical current to these conductive layers at the upper portion thereof, this communication apparatus propagates an electromagnetic wave between the conductive layers, and performs communication.

The communication apparatus that is shown in Patent Document 3 has a signal transmission apparatus that interposes a dielectric between mesh-type first conductor portion and second conductor portion. In a communication coupler that is connected to this signal transmission apparatus, electromagnetic waves are supplied to the signal transmission apparatus by an inner conductor and an outer conductor portion that covers this inner conductor.

The communication apparatus that is shown in Patent Document 4 has a signal transmission apparatus in which a layer is formed that consists of a vacuum or a dielectric between a mesh-type first conductor portion and second conductor portion, a communication coupler that is connected to this signal transmission apparatus, electromagnetic waves are supplied to the signal transmission apparatus by an inner conductor and an outer conductor portion that covers this inner conductor.

### PRIOR ART DOCUMENT

### Patent Document

[Patent Document 1] Japanese Unexamined Patent Application, First Publication No. 2009-105599

[Patent Document 2] PCT International Publication No. WO 2006/35534

[Patent Document 3] PCT International Publication No. WO 2007/32049

[Patent Document 4] PCT International Publication No. WO 2006/32339

### SUMMARY OF THE INVENTION

### Problem to be Solved by the Invention

However, in the communication systems that are shown in Patent Document 1 and Patent Documents 2 to 4, there is a problem of electromagnetic field leakage particularly in the communication coupler 2. Using FIG. 15 the path of electromagnetic field leakage in this communication system shall be explained.

As described above, an electromagnetic field that is a signal that is input from the communication equipment 14 is injected to the signal transmission apparatus 1 by propagating between the disk-shaped inner conductor 10 and the outer conductor 12 of the communication coupler 2 via the coaxial cable 13. At this time, some of the electromagnetic field leaks outward through the first dielectric layer 5 and the like that is between the bottom of the communication coupler 2 and the mesh conductor portion 3 that is a mesh-type conductor of the signal transmission apparatus 1, as shown by the arrows R in FIG. 15. Specifically, as shown in FIG. 15, in the case of using with the communication coupler 2 installed on the signal transmission apparatus 1, an electromagnetic field leaks through the first dielectric layer 5 and the like that is between the lower portion of the outer conductor 12 of the communication coupler 2 and the mesh conductor portion 3 of the signal transmission apparatus 1. FIG. 16A is a diagram that magnifies the location of the electromagnetic field leakage path. FIG. 16B shows a parasitic capacitance Cs1 that is formed between the lower portion of the outer conductor 12 of the communication coupler 2 (the conductor portion between point P1 and point P2) and the lower electrode 4 of the signal transmission apparatus 1 (the conductor portion between point P3 and point P4).

In the aforementioned communication systems that are shown in FIG. 12 to FIG. 16B, since it is not possible to ensure a sufficient parasitic capacitance Cs1 between the lower portion of the outer conductor 12 of the communication coupler 2 (the conductor portion between point P1 and point P2) and the lower electrode 4 of the signal transmission apparatus 1 (the conductor portion between point P3 and point P4), there has been the problem of electromagnetic wave leakage occurring during communication.

The leaking of an electromagnetic field carrying a signal from communication system his way is not preferred since it leads to information leakage even if the communication system s provided with a security function such as encryption. In addition, due to the possibility of a leaked electromagnetic field imparting an effect to the operation of another electronic device, it is necessary to reduce leakage.

The present invention have been conceived in view of the above circumstances, and has as an object thereof to provide a communication system that can inhibit the generation of electromagnetic leakage, from contact locations of the communication coupler and the signal transmission apparatus.

### Means for Solving the Problem

In order to solve the aforementioned issues, a communication system according to the present invention includes: a communication coupler that transmits a signal outputted from a communication equipment; and a signal transmission apparatus that performs communication by propagating, as an electromagnetic field, a signal transmitted from the communication coupler. The communication coupler includes: a coupler case; and an extended conductor portion that is provided at an end portion of the coupler case, the end portion facing the signal transmission apparatus, the extended conductor portion extends so as to be parallel to the signal transmission apparatus, and the extended conductor portion increases electromagnetic coupling between the communication coupler and the signal transmission apparatus.

### Effect of the Invention

According to the present invention, at the end portion of a coupler case that faces a signal transmission apparatus of a communication coupler, an extended conductor portion that is extended so as to be parallel to this signal transmission apparatus is provided. By this kind of extended conductor portion, it is possible to increase electromagnetic coupling between the communication coupler and the signal transmission apparatus, and in particular electromagnetic coupling between the outer conductor of the communication coupler and the lower electrode of the signal transmission apparatus, and a high-quality communication system with little leaking electromagnetic field becomes possible.

### BRIEF DESCRIPTION OF THE DRAWINGS

FIG. 1 is a cross-sectional view that shows an entire communication system according to a first exemplary embodiment of the present invention.

FIG. 2 is a perspective view that shows a communication coupler in the communication system of FIG. 1.

FIG. 3 is a cross-sectional view of the communication coupler shown in FIG. 2.

FIG. 4A is a cross-sectional view corresponding to FIG. 1 that shows a parasitic capacitance of the location that becomes a electromagnetic field leakage path of the communication coupler and the signal transmission apparatus.

FIG. 4B is a schematic view of FIG. 4A.

FIG. 5 is an explanatory diagram that shows the procedure of assembling the communication coupler shown in FIG. 1.

FIG. 6 is a cross-sectional view of a communication coupler according to a second exemplary embodiment of the present invention.

FIG. 7 is a cross-sectional view of a communication coupler according to a third exemplary embodiment of the present invention.

FIG. 8 is a cross-sectional view of a communication coupler according to a fourth exemplary embodiment of the present invention.

FIG. 9 is a cross-sectional view of an EBG structure provided in a communication coupler according to a fifth exemplary embodiment of the present invention.

FIG. 10 is a cross-sectional view that concretely shows the EBG structure of FIG. 9.

FIG. 11A is a perspective view that shows the entire communication coupler in which the EBG structure shown in FIG. 9 is attached.

FIG. 11B is an explanatory diagram that concretely shows the installation location of the EBG structure with respect to the communication coupler shown in FIG. 9.

FIG. 12 is a cross-sectional view that shows an entire conventional communication system.

FIG. 13 is a plan view that shows a signal transmission apparatus in the communication system of FIG. 12.

FIG. 14 is a perspective view that shows a communication coupler in the communication system of FIG. 12.

FIG. 15 is a cross-sectional view for describing the electromagnetic field leakage between the communication coupler and the signal transmission apparatus, in the communication system of FIG. 12.

FIG. 16A is a cross section view corresponding to FIG. 12 that hows a parasitic capacitance of the location that becomes a electromagnetic field leakage path of the conventional communication coupler and signal transmission apparatus.

FIG. 16B is a schematic diagram of FIG. 16A.

### EMBODIMENTS FOR CARRYING OUT THE INVENTION

### First Exemplary Embodiment

A first exemplary embodiment of the present invention shall be described in detail with reference to FIG. 1 to FIG. 5.

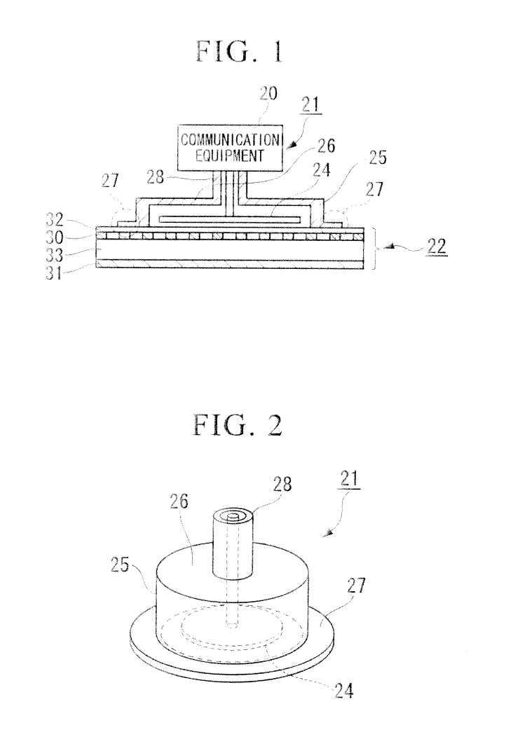

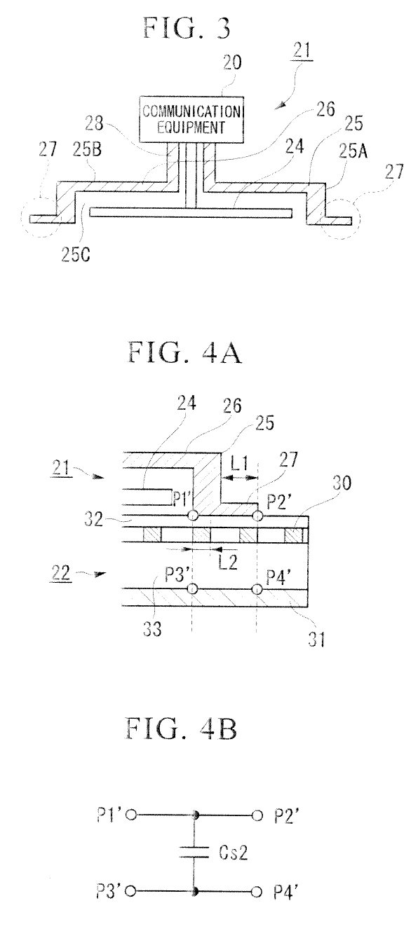

FIG. 1 shows a communication system that includes a communication coupler 21 that transmits signals that have been outputted from a communication equipment 20, and a signal transmission apparatus 22 that performs communication by propagating, as an electromagnetic field, the signals that have been transmitted from this communication coupler 21. FIG. 2 and FIG. 3 are diagrams that show portions of the communication coupler 21 in the communication system.

As shown in FIGS. 2 and 3, the communication coupler 21 has a disk-shaped inner conductor 24, and an outer conductor 26 that constitutes a coupler case 25 by being arranged so as to cover he inner conductor 24. A flange portion 27 (extended conductor portion) is provided at the end portion of the outer conductor 26, which constitutes the coupler case 25, that faces the signal transmission apparatus 22. The flange portion 27 is extended so as to be parallel to the sheet-type signal transmission apparatus 22 (described below). The inner conductor 24 and the outer conductor 26 that constitute the coupler case 25 are connected to the communication equipment 20 via a coaxial cable 28.

The coupler case 25 has a cylindrical portion 25A that is formed in an overall cylindrical shape, and a lid portion 25B provided at an end portion of the cylindrical portion 25A, as shown in FIG. 3. The disk-shaped inner conductor 24 is arranged in an internal space 25C of the coupler case 25. The flange portion 27 has a shape that extends outward, at the lower end portion and outer side position of the cylindrical portion 25A of the outer conductor 26 in the manner of a brim of a hat. Adding the flange 27 to this kind of outer conductor 26 inhibits a leaking electromagnetic field.

A voltage is impressed on the inner conductor 24 and the outer conductor 26 by a signal that is output from the communication equipment 20, and an electromagnetic field is generated by this voltage between the inner conductor 24 and the outer 25. At this time, increasing the electromagnetic coupling between the communication coupler 21 and the signal transmission apparatus 22, in particular, the electromagnetic coupling region between the outer conductor 26 of the communication coupler 21 and the lower electrode 31 (described below) of the signal transmission apparatus 22 by the aforementioned flange portion 27 that is provided at the aforementioned outer conductor 26 enables communication with little leaking electromagnetic field.

The signal transmission apparatus 22 is a sheet-type structure that has a mesh conductor portion 30 with a mesh -state, a lower electrode 31, a first dielectric layer 32, and a second dielectric layer 33. The lower electrode 31 is provided spaced apart from the mesh conductor portion 30. The first dielectric layer 32 is provided on the upper portion of the mesh conductor portion 30. The second dielectric layer 33 is provided in the sandwiched region between the mesh conductor portion 30 and the lower electrode 31.

The length of the flange portion 27 of the communication coupler 21 that faces the signal transmission apparatus 22 is set to be longer than the single conductor width that constitutes the mesh of the mesh conductor portion 30 of the signal transmission apparatus 22, in order to increase the electromagnetic leakage suppression effect (described below).

Electromagnetic field leakage between the communication coupler 21 and the signal transmission apparatus 22 shall be described.

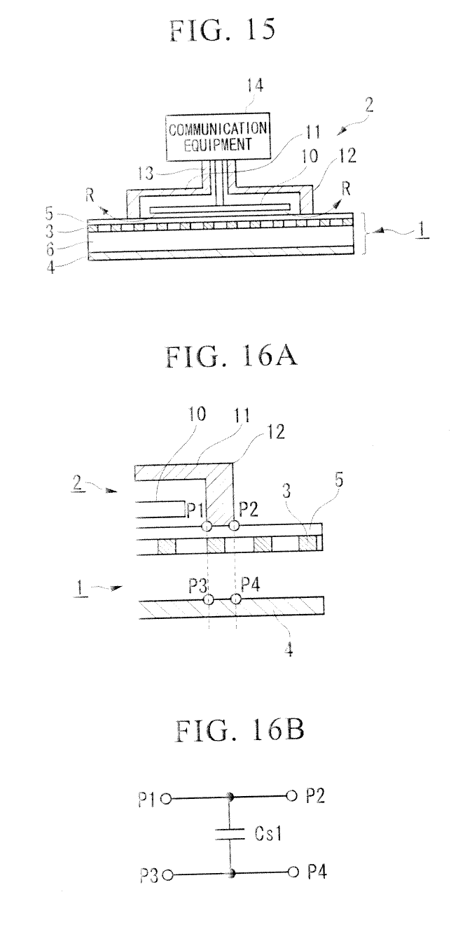

As described above, in the case of using the conventional communication coupler 2 shown in FIG. 15 installed on the signal transmission apparatus 1, an electromagnetic field leaks through the first dielectric layer 5 and the like that is between the lower portion of the outer conductor 12 of the communication coupler 2 and the mesh conductor portion 3 that is a mesh-type conductor of the signal transmission apparatus 1. When the filling density of the mesh-type mesh conductor portion 3 in the signal transmission apparatus 1 (the ratio that the mesh conductor occupies) is small, for example, in the case of a mesh conductor width of 1 mm, and a mesh conductor interval of 7 mm, a method of suppressing the aforementioned electromagnetic field leakage includes increasing the electromagnetic coupling of the lower portion of the outer conductor 12 of the communication coupler 2 and the lower electrode 4 of the signal transmission device 1. That is to say, by increasing the parasitic capacitance that is created from a lower portion of the outer conductor 12 and an upper portion of the lower electrode 4, the ratio of the electromagnetic field that is injected from the communication coupler 2 to the signal transmission apparatus 1 increases, and the amount that leaks to the outside through the first dielectric layer decreases.

Electromagnetic field leakage in the case of installation of the conventional communication coupler on the signal transmission apparatus 1 is shown in FIG. 16A and FIG. 16B.

FIG. 4A shows the case of the communication coupler 21 of the first exemplary embodiment of the present invention being installed on the signal transmission apparatus 22.

FIG. 4B shows a parasitic capacitance Cs2 that is formed between the lower portion of the outer conductor 26 with the added flange portion 27 of the communication coupler 21 (the conductor portion between point P1′ and point P2′ in FIG. 4A) and the lower electrode 31 of the signal transmission apparatus 22 (the conductor portion between point P3′ and point P4′ in FIG. 4A). By adding the flange portion 27, in the communication system of the first exemplary embodiment of the present invention, compared to a conventional communication system, the region of the lower portion of the outer conductor 26 that faces the signal transmission apparatus 22 becomes larger, and the opposing surface area to the lower electrode 31 that is positioned therebelow increases. As a result, since the parasitic capacitance increases (Cs1<Cs2) the impedance decreases, and the electromagnetic field leakage to the outside of the communication system becomes less in addition to the electromagnetic field that propagates between the inner conductor 24 and the outer conductor 26 of the transmission coupler being easily injected to the signal transmission apparatus 22.

The more that the lower portion of the outer conductor 26 including the flange portion 27 is longer than the conductor width of the mesh conductor, the more an electromagnetic field leakage suppression effect is obtained. Therefore, in the case of the length of the flange portion 27 being L1, and the width of a single conductor frame that constitutes the mesh conductor portion 30 being L2, it is preferable to set the length of the flange portion 27 to he L1>L2.

A method of manufacturing the communication coupler 21 shall be simply described using FIG. 5. The inner conductor 24 and the outer conductor 26 with the flange portion 27 of the communication coupler 21 are manufactured by a method such as casting, for example. Using a coaxial connector is conceivable for the connection of the communication coupler 21 and the coaxial cable 28. An outer conductor 29A of the coaxial connector 29 and the outer conductor 26 of the communication coupler 21, and an inner conductor 29B of the coaxial connector 29 and the inner conductor 24 of the communication coupler 21 are respectively connected by soldering. A hole that allows the inner conductor 29B of the coaxial connector 29 to be pushed in is formed in a center projection of the inner conductor 24 in advance. As described above the communication coupler 21 of the first exemplary embodiment of the present invention can be achieved by a general construction method.

As described in detail above, according to the communication system that is shown in the first exemplary embodiment, the flange portion 27 (extended conductor portion) that is extended so as to be parallel to the signal transmission apparatus 22 is provided at the end portion of the outer conductor 26 of the communication coupler 21. By increasing electromagnetic coupling between the communication coupler 21 and the signal transmission apparatus 22, in particular, electromagnetic coupling between the outer conductor 26 of the communication coupler 21 and the lower electrode 31 of the signal transmission apparatus 22 with this flange portion 27, high-quality communication with little leaking electromagnetic field becomes possible.

### Second Exemplary Embodiment

Next, a second exemplary embodiment of the present invention shall be described referring to FIG. 6.

The communication system of the second exemplary embodiment differs from the preceding first exemplary embodiment on the point of the material that constitutes the coupler case 25 of the communication coupler 21. That is to say, in the first exemplary embodiment, the coupler case 25 of the communication coupler 21 is constituted by metal. In contrast, in the second exemplary embodiment, the communication coupler 21 of the second exemplary embodiment is constituted by constituting a coupler case 40 with a non-conductor such as resin, and partially applying a conductor plating 41 to this coupler case 40.

The coupler case 40 of FIG. 6 is manufactured such as by injection molding the constituent resin. Then, in order to make a connection with the coaxial cable 28 that leads to the transmission device 20, the conductor plating 41 is applied to at least the connection location with the coaxial cable 28 (indicated by reference symbol 41A), the facing surface on the inner conductor 24 side (indicated by reference symbol 41B) and the entire lower end surface of the coupler case 40 including the flange portion 27 (indicated by reference symbol 41C). The thickness of the conductor plating 41 is thicker than the conductor skin thickness at the frequency used in communication.

By constituting the outer conductor with the coupler case 40 consisting of resin, and applying conductor plating 41 to the necessary portions of the coupler case 40 in this way, it becomes possible to further prevent excessive electromagnetic field leakage.

### Third Exemplary Embodiment

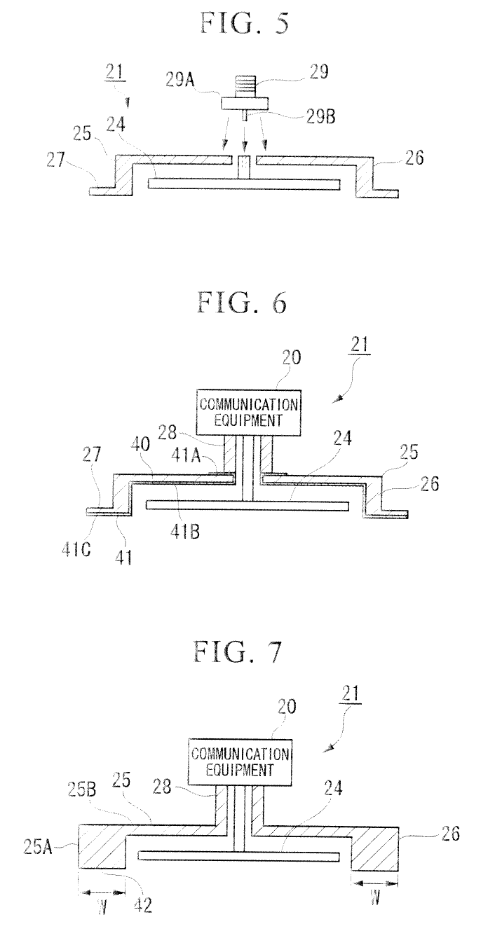

Next, a third exemplary embodiment of the present invention shall be described referring to FIG. 7.

The communication system of the third exemplary embodiment differs from the preceding first exemplary embodiment on the point of the constitution of the flange portion 27, which is provided as an extended conductor portion in the first exemplary embodiment. In the first exemplary embodiment, as shown in FIG. 1, the flange portion 27 that extends the outer conductor 26 to the outer side is provided as an extended conductor portion at the bottom portion of the outer conductor 26 of the communication coupler 21. In contrast, in the third exemplary embodiment, as shown in FIG. 7, in the coupler case 25 that has the cylindrical portion 25A that is formed in an overall cylindrical shape and the lid portion 25B that is provided at the upper end portion of the cylindrical portion 25A, by forming the thickness of the cylindrical portion 25A (indicated by the reference symbol W) to be thick, the bottom portion of the lower end portion of the cylindrical portion 25A serves as an extended conductor portion 42.

In the case where the thickness W of the cylindrical portion 25A and the coupler case 25 are constituted by applying the conductor plating 41 to the coupler case 40 consisting of resin as indicated by the preceding second exemplary embodiment, by setting the thickness of the conductor plating 41 (conductor skin thickness) to be “thickness W of cylindrical portion 25A>>conductor skin thickness”, high quality communication with little leaking electromagnetic field is enabled.

This kind of extended conductor portion 42 increases electromagnetic coupling between the communication coupler 21 and the signal transmission apparatus 22, in particular, the electromagnetic coupling region between the outer conductor 26 of the communication coupler 21 and the lower electrode 31 of the signal transmission apparatus 22, in the same manner as the first exemplary embodiment. As a result, high quality communication with little leaking electromagnetic field becomes possible, and the overall shape does not become complicated unlike with the outer conductor 26 that has the flange portion 27 of the first exemplary embodiment, and the effect is also obtained of manufacture of the die that is used in the molding being easy. As the method of manufacturing of the communication coupler 21 that is shown in the third exemplary embodiment, it is possible to use the same method as first exemplary embodiment.

### Fourth Exemplary Embodiment

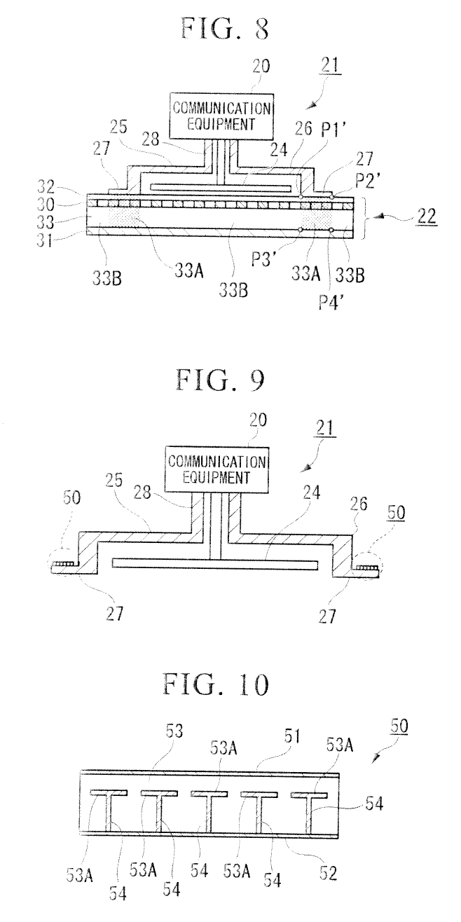

Next, a fourth exemplary embodiment of the present invention shall be described referring to FIG. 8.

In this fourth exemplary embodiment, a partial region of the dielectric layers 32 and 33 that constitute the signal transmission apparatus 22 is replaced with a material having a high dielectric constant (indicated by reference symbol 33A).

Specifically, the first dielectric layer 32 and the second dielectric layer 33 between the lower portion of the outer conductor 26 where the flange portion 27 is formed of the communication coupler 21 and the lower electrode 31 of the signal transmission apparatus 22 that opposes it, that is to say, the region enclosed by point P1′, point P2′, point P4′, point P3′ shown in FIG. 8 is replaced with a material having a higher dielectric constant than the material of another region (indicated by reference symbol 33B). Thereby, by further increasing the parasitic capacitance Cs2 between the flange portion 27 and the lower electrode 3 I where electromagnetic field leakage easily occurs, it is possible to effectively suppress electromagnetic field leakage. However, by adopting the constitution as shown in this fourth exemplary embodiment, the installation place of the communication coupler 21 on the signal transmission apparatus 22 is limited.

### Fifth Exemplary Embodiment

Next, a fifth exemplary embodiment of the present invention shall be described referring to FIG. 9 to FIG. 11B.

In the aforementioned first exemplary embodiment, when the length of the flange portion 27 becomes comparable to a one-half wavelength at the frequency used in communication, current appears on the flange portion 27, and triggers electromagnetic radiation by functioning as an antenna. A structure for inhibiting this radiation is this fifth exemplary embodiment.

That is to say, in the fifth exemplary embodiment, as shown in FIG. 9, an EBG (Electromagnetic-BandGap) structure 50 that inhibits the propagation of electromagnetic fields in a specified frequency band is formed on the upper surface of the flange portion 27 that is provided as an extended conductor portion. In relation to the EBG structure, there are reports such as “Electromagnetic-Bandgap Layers for Broad-Band Suppression of TEM Modes in Power Planes” appearing in pp. 2495-2505 of IEEE Transactions On Microwave Theory And Techniques, Vol. 53, No. 8, August 2005, (hereinbelow referred to as Document A).

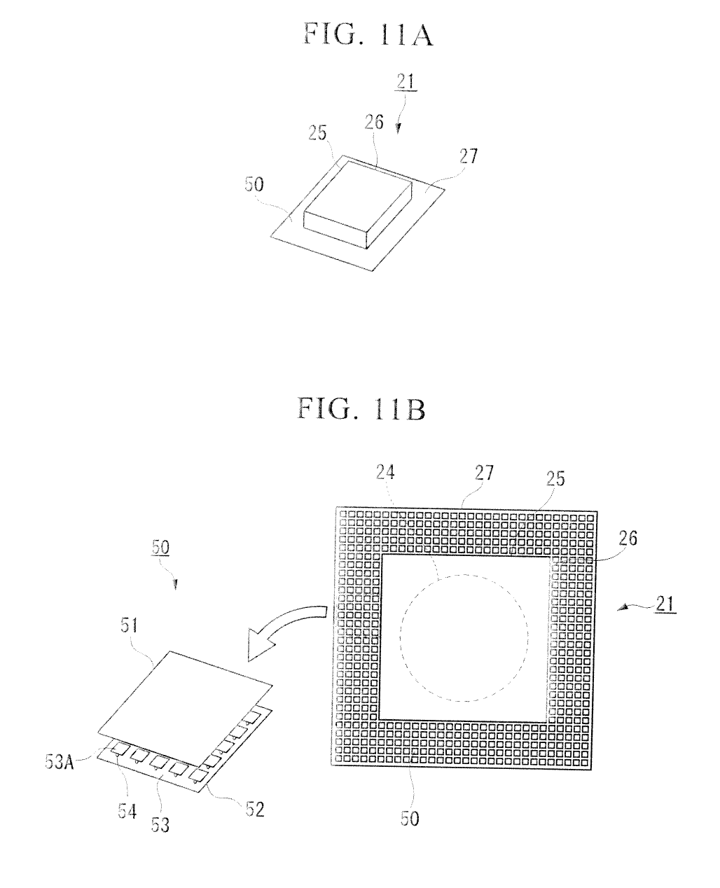

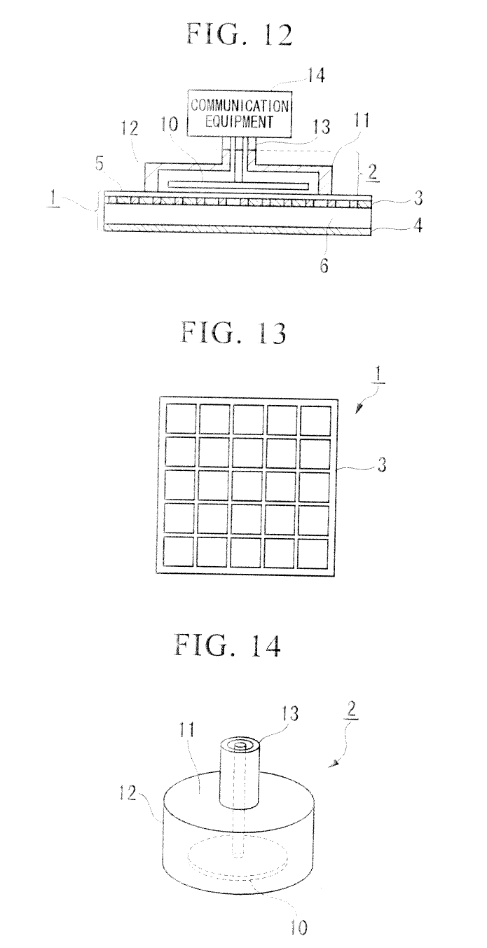

This EBG structure 50 has as plate-shaped conductor sheets an upper-layer conductor layer 51 and a lower-layer conductor layer 52 that include printed circuit hoards, as shown by the cross-sectional view in FIG. 10. Also, in the EBG structure 50, a conductor pattern 53 that includes square conducting objects 53A in plan view is formed between the conductor layer 51 and the conductor layer 52. As shown in FIGS. 11A and 11B, the EBG conductor 50 is constituted by connecting the conducting object 53A and the conductor layer 52 with a conductor via 54, and two-dimensionally arranging a plurality of the assemblies of the conductor pattern 53 that includes a square conducting object 53A and the conductor via 54 at a fixed period and interval.

The dimensions of each portion are noted in Table I and FIG. 8 on pp. 2499 of the aforementioned Document A (the structure is given in FIG. 2 of Document 1). This EBG structure 50 is installed on the flange portion 27 of the communication coupler 21, as shown in FIGS. 11 and 11B. During the installation, the conductor layer 52 of the lower layer that constitutes the EBG structure 50 and the flange portion 27 are electrically connected by an electrically conductive adhesive or the like. In the case of installing the EBG structure 50 on the flange portion 27, the outer conductor 26 of the communication coupler 21 and the flange portion 27 that is arranged on the circumference thereof are preferably square instead of round as shown in FIG. 11B, for ease of arrangement.

In the aforementioned fifth exemplary embodiment, the electromagnetic coupling between the communication coupler 21 and the signal transmission apparatus 22, in particular, the electromagnetic coupling between the outer conductor 26 of the communication coupler 21 and the lower electrode 31 of the signal transmission apparatus 22 increase, in the same manner as the first exemplary embodiment, by the flange portion 27 that is arranged on the periphery of the outer conductor 26. As a result, high-quality communication with little leaking electromagnetic field becomes possible. Moreover, by the EBG structure 50 on the flange portion 27, the phenomenon of the flange portion 27 triggering electromagnetic radiation by functioning as an antenna is prevented, and on this point as well high-quality communication with little leaking electromagnetic field becomes possible.

Hereinabove, exemplary embodiments of the present invention have been described in detail referring to the drawings, but specific constitutions are not limited to these exemplary embodiments, and design modifications are included without departing from the scope of the invention.

This application is based upon and claims the benefit of priority from Japanese patent application No. 2009-202114, filed Sep. 1, 2009, the disclosure of which is incorporated herein in its entirety by reference.

### INDUSTRIAL APPLICABILITY

The present invention may be applied to a communication system that includes a sheet-type signal transmission apparatus and a communication coupler that is installed thereon and transmits signals to a signal transmission apparatus, and in particular may be applied to a leaking electromagnetic field suppression structure that suppresses electromagnetic field leakage of a communication coupler.

### DESCRIPTION OF REFERENCE SYMBOLS

20 Communication equipment
21 Communication coupler
22 Signal transmission apparatus
24 Inner conductor
25 Coupler case
25A Cylindrical portion
25B Lid portion
26 Outer conductor
27 Flange portion (extended conductor portion)
30 Mesh conductor portion
31 Lower electrode
32 First dielectric layer
33 Second dielectric layer
40 Coupler case
41 Conductor plating
42 Extended conductor portion
50 EBG structure

1. A communication system comprising:
a communication coupler that transmits a signal outputted from a communication equipment; and
a signal transmission apparatus that performs communication by propagating, as an electromagnetic field, a signal transmitted from the communication coupler, the communication coupler comprising:
a coupler case; and
an extended conductor portion that is provided at an end portion of the coupler case, the end portion facing the signal transmission apparatus, the extended conductor portion extending so as to be parallel to the signal transmission apparatus, and the extended conductor portion increasing electromagnetic coupling between the communication coupler and the signal transmission apparatus.

2. The communication system according to claim 1, wherein the extended conductor portion [is] comprises a flange portion that is provided so as to project outward from the coupler case in a radial direction.

3. The communication system according to claim 1,
wherein the coupler case of the communication coupler includes a cylindrical portion that has an overall cylindrical shape, and a lid portion that is provided at an upper end portion of the cylindrical portion, and an inner conductor is arranged in an internal space of the coupler case, and
a thickness of the cylindrical portion is sufficiently thicker than a thickness of a skin of a conductor that constitutes the cylindrical portion, so that a bottom portion of a lower end portion of the cylindrical portion serves as the extended conductor portion.

4. The communication system according to claim 1,
wherein the signal transmission apparatus [is] comprises a sheet-shaped structure, and includes: a sheet structure that has a mesh conductor portion having a mesh shape; a lower electrode that is arranged spaced apart from the mesh conductor portion; and a dielectric layers that are provided on an upper layer and lower layer of the mesh conductor portion, and
a length of the extended conductor portion that faces the signal transmission apparatus is longer than a width of a single conductor that constitutes a mesh of the mesh conductor portion of the signal transmission apparatus.

5. The communication system according to claim 1,
wherein the coupler case of the transmission coupler [is constituted by] includes a non-conductor such as resin; and
the extended conductor portion is formed by applying a metal plating to a surface of an end portion facing the signal transmission apparatus that includes the coupler case.

6. The communication system according to claim 5, wherein the extended conductor portion has a thickness that is sufficiently greater than a thickness of a skin of the metal plating.

7. The communication system according to claim 4, wherein the dielectric layers of the signal transmission apparatus are filled in a region that is arranged facing the extended conductor portion with a substance having a higher dielectric constant than another region.

8. The communication system according to claim 2, wherein an EBG structure is provided on the flange portion, and prevents a phenomenon of the flange portion triggering electromagnetic radiation by functioning as an antenna.

9. The communication system according to claim 2,
wherein the signal transmission apparatus comprises a sheet-shaped structure, and includes: a sheet structure that has a mesh conductor portion having a mesh shape; a lower electrode that is arranged spaced apart from the mesh conductor portion; and a dielectric layers that are provided on an upper layer and lower layer of the mesh conductor portion, and
a length of the extended conductor portion that faces the signal transmission apparatus is longer than a width of a single conductor that constitutes a mesh of the mesh conductor portion of the signal transmission apparatus.

10. The communication system according to claim 3,
wherein the signal transmission apparatus comprises a sheet-shaped structure, and includes: a sheet structure that has a mesh conductor portion having a mesh shape; a lower electrode that is arranged spaced apart from the mesh conductor portion; and a dielectric layers that are provided on an upper layer and lower layer of the mesh conductor portion, and
a length of the extended conductor portion that faces the signal transmission apparatus is longer than a width of a single conductor that constitutes a mesh of the mesh conductor portion of the signal transmission apparatus.

11. The communication system according to claim 2,
wherein the coupler case of the transmission coupler comprises a non-conductor such as resin; and
the extended conductor portion is formed by applying a metal plating to a surface of an end portion facing the signal transmission apparatus that includes the coupler case.

12. The communication system according to claim 3,
wherein the coupler case of the transmission coupler comprises anon-conductor such as resin; and
the extended conductor portion is formed by applying a metal plating to a surface of an end portion facing the signal transmission apparatus that includes the coupler case.

13. The communication system according to claim 4,
wherein the coupler case of the transmission coupler comprises a non-conductor such as resin; and
the extended conductor portion is formed by applying a metal plating to a surface of an end portion facing the signal transmission apparatus that includes the coupler case.

14. The communication system according to claim 5, wherein the dielectric layers of the signal transmission apparatus are filled in a region that is arranged facing the extended conductor portion with a substance having a higher dielectric constant than another region.

15. The communication system according to claim 6, wherein the dielectric layers of the signal transmission apparatus are filled in a region that is arranged facing the extended conductor portion with a substance having a higher dielectric constant than another region.

16. The communication system according to claim 4, wherein an EBG structure is provided on the flange portion, and prevents a phenomenon of the flange portion triggering electromagnetic radiation by functioning as an antenna.

17. The communication system according to claim 5, wherein an EBG structure is provided on the flange portion, and prevents a phenomenon of the flange portion triggering electromagnetic radiation by functioning as an antenna.

18. The communication system according to claim 6, wherein an EBG structure is provided on the flange portion, and prevents a phenomenon of the flange portion triggering electromagnetic radiation by functioning as an antenna.

19. The communication system according to claim 7, wherein an EBG structure is provided on the flange portion, and prevents a phenomenon of the flange portion triggering electromagnetic radiation by functioning as an antenna.
